(19) United States
(12) Patent Application Publication
(10) Pub. No.: US 2015/0103861 A1
(43) Pub. Date: Apr. 16, 2015

(54) TESTING APPARATUS AND METHOD

(71) Applicant: United States Gypsum Company, Chicago, IL (US)

(72) Inventors: Bangji CAO, Naperville, IL (US); Scott LECKIE, McHenry, IL (US); Weixin D. SONG, Vernon Hills, IL (US); Cesar CHAN, Libertyville, IL (US)

(73) Assignee: United States Gypsum Company, Chicago, IL (US)

(21) Appl. No.: 14/054,649

(22) Filed: Oct. 15, 2013

(51) Int. Cl. G01K 3/04

(52) U.S. Cl. CPC G01K 3/04
USPC 374/103; 29/407.05

(57) ABSTRACT

A system and method for predicting wallboard fire performance in a standard test includes procuring a sample of the wallboard for testing, and mounting the sample into a fixture so that one side of the sample is exposed to a heat source. A cavity is created between the sample and the fixture such that the sample is disposed between the heat source and the cavity. A temperature measurement is taken at a predetermined location within the cavity over time, and the temperature is monitored and recorded as a series of temperature readings using a computer-readable medium. The series is analyzed to determine an index time at which the temperature reaches a predetermined temperature threshold. The index time is correlated to a standard-test fire performance using the computer-readable medium and, based on the correlation, a fire performance of the wallboard in a standard test procedure is predicted.

### BACKGROUND

Fire endurance and/or resistance of gypsum wallboard is generally a standardized testing procedure that can be carried out for various different wall construction types. Typical testing is carried out to determine the time required for a passive wall structure, which includes gypsum board assembled onto studs, to fail when exposed to a standard fire. The fire endurance of a system can depend on various factors, for example, the type and thickness of gypsum board used in the system, the wall structure and/or thickness, the type of studs used to construct the wall, stud spacing, gypsum board size and orientation, use of insulation in the wall cavity, load bearing of the wall, and others. For objectively evaluating fire endurance of wall structures, standardized testing has been developed for some commonly used wall structures.

The most common assemblies are three test designs defined by Underwriters Laboratories, Inc. (UL®), a third party testing and certification agency. These common tests, which are designated as U305, U419, and U423, test wall assemblies using wooden or metal studs for walls having wall boards assembled on both sides of the studs and at various wall thicknesses, where the walls may or may not be load bearing. For a fire rating to be assigned to a particular board, a minimum time to failure must be exhibited by the wall board before failure occurs. In this context, failure involves a loss of wall integrity due to fire, or excessive temperature rise. Excessive temperature rise failures are determined when the average temperature of the unexposed surface of the wallboard increases more than 121.1° C. (250° F.) above ambient, or any individual thermocouple in the test assembly rises more than 162.8° C. (325° F.) above ambient.

Gypsum is widely used in residential and commercial building constructions because of its superior fire endurance. Gypsum's chemical composition is calcium sulfate dihydrate (CaSO₄.2H₂O). The two water molecules in gypsum crystals are chemically bonded and it is often termed “crystallized water”. It is those two molecules of water that render gypsum high heat resistance. Upon reaching about 101.7° C. (about 215° F.), one and half molecules of water are driven off from one molecule of gypsum as it is converted into hemihydrates (CaSO₄.½ H₂O). When the temperature reaches 121.1° C. (250° F.), the remaining half molecule water is lost as gypsum is converted into anhydrite (known as stucco). Both reactions are endothermic, which enables heat absorption by the gypsum as it is converted from dihydrate to anhydrite. The combined thermal energy requirement amounts to 9.828e+004 calories (390 BTU)/lb or 906 kJ/kg. Each of these two reactions, as they occur successively while a sample is heated, occurs at its respective temperature such that a temperature trace will exhibit two inflection points, one near 121.1° C. (250° F.) and the other near 100° C. (212° F.). At the second inflection point, the slope of the curve will also change in part due to latent heat for free water evaporation.

The crystallized water loss process is commonly referred to as calcination. After calcination is completed, heat transfer through the gypsum board becomes a basic heat transfer process by conduction, convection, and radiation. In a wallboard test assembly, heat is first transferred from the furnace to the surface of exposed board through a combination of convection, conduction and radiation. As the surface temperature of the exposed wallboard increases, the temperature gradient across the board increases. If the wallboard maintains its structural integrity during a fire, it effectively blocks the passage of flame and hot air. During this condition, the primary mode of heat transfer is conduction through board. Conductive heat transfer through the board depends on thermal conductivity of the wallboard. Inside the cavity formed between two wallboards in a stud wall assembly, heat is primarily transferred through convection and conduction. Convection is attributed to air circulation within the cavity between the two boards in a wall assembly. Heat conduction within the wall cavity is also present during testing. At those unexposed wallboard surfaces within the cavity, i.e., wallboard portions exposed between studs, heat is transferred from the cavity side to the outer, ambient side at a lower rate because of the lower temperature gradient that exists between the cavity and the outer portion of the wall.

Fire endurance ratings are typically obtained by performing a full-size (at least 100 ft² of wall area) fire test in a certified fire test laboratory per ASTM standards. The test is time-consuming and expensive. Moreover, the scale of standard testing is not well suited for laboratory testing of wallboard samples during new product development, end-of-line quality control testing, or the like. These and other drawbacks of standardized testing methods and systems can be overcome as provided herein.

### SUMMARY

In one aspect, the disclosure describes a method for predicting wallboard fire performance in a standard test. The method includes mounting a sample of a wallboard to be tested into a fixture so that one side of the sample is exposed to a heat source. A cavity is created between the sample and the fixture such that the sample is disposed between the heat source and the cavity. A temperature is measured and monitored at a predetermined location within the cavity over time. A series of temperature readings is recorded using a computer-readable medium and analyzed, at least in part, by creating a temperature trace of the series of temperature readings over time. An index time at which the temperature reaches a predetermined temperature threshold at the predetermined location within the cavity is determined. The index time is correlated to a standard-test fire performance using the computer-readable medium and, based on the correlation, a fire performance of the wallboard in a standard test procedure is predicted.

In another aspect, the disclosure describes a method for testing the fire endurance and/or performance of a wallboard sample. The method includes mounting the wallboard sample across an opening of a chamber of a muffle furnace having temperature control, wherein one side of the wallboard sample is exposed to an oven temperature. A cavity is created between the wallboard sample and an oven door configured to enclose the chamber. A sample temperature is measured at a predetermined location within the cavity over time. The sample temperature is monitored and recorded with respect to time using a computer-readable storage medium. Sample temperature information is analyzed, at least in part, by creating a temperature trace and by determining an index time at which the sample temperature reaches a predetermined temperature threshold. The index time is correlated to a standard-test fire performance using the computer-readable medium and, based on the correlation, a fire performance of the wallboard in a standard test procedure is predicted.

In yet another aspect, the disclosure describes a method for producing wallboard. The method includes building a composite wallboard structure in a manufacturing facility using a particular batch of gypsum slurry to form a core portion of the composite wallboard structure. A sample of the composite wallboard structure is extracted. The sample is tested in a small-scale test so that a fire performance of the composite wallboard structure in a full-scale test can be extrapolated. In one embodiment, the small-scale testing is carried out by mounting the sample into a fixture so that one side of the sample is exposed to a heat source, creating a cavity between the sample and the fixture, wherein the sample is disposed between the heat source and the cavity, and measuring a temperature at a predetermined location within the cavity over time. The temperature is monitored over time and a series of temperature readings is recorded using a computer-readable medium. The series of temperature readings is analyzed, at least in part, by creating a temperature trace of the series of temperature readings over time, and by determining an index time at which the temperature reaches a predetermined temperature threshold at the predetermined location within the cavity. The index time is correlated to the full-scale test using the computer-readable medium and, based on the correlation, a fire performance of the composite wallboard structure in the full-scale test is predicted. The composite wallboard structure is released for sale to consumers when the fire performance of the composite wallboard structure is predicted to be within acceptable parameters.

### BRIEF DESCRIPTION OF THE DRAWINGS

FIG. 1 illustrates a cross section of a wall board in accordance with the disclosure.

FIG. 2 illustrates a side view of a board forming system in accordance with the disclosure.

FIG. 3 illustrates a top view of a board forming system in accordance with the disclosure.

FIG. 4 is a representative temperature trace for a tested sample in accordance with the disclosure.

FIG. 5 is a chart illustrating a correlation between testing methods in accordance with the disclosure.

FIG. 6 is a temperature trace for treated and untreated samples tested in accordance with the disclosure.

FIG. 7 is a temperature trace for treated and untreated samples tested in a standard test.

FIG. 8 is a flowchart for a testing method in accordance with the disclosure.

### DETAILED DESCRIPTION

The present disclosure is applicable to small-scale testing of board fire endurance such as in a laboratory setting or for quality control in board manufacturing operations. The present disclosure describes a system and a method for small-scale fire testing that is useful for preditcitng the full-scale standard fire endurance and/or resistance testing of wallboard. The small-scale test can be implemented to predict the performance of various board types for both research and quality control purposes. For example, a testing system and/or testing method as described herein can be used by a manufacturer to test different production batches to ensure consistent product quality and adherence to design specifications, a task that was either impossible or time-consuming and expensive with known testing methods.

In one disclosed embodiment, the small-scale fire test device or test fixture includes a muffle furnace with temperature control. As used herein, muffle furnace refers to a furnace in which the sample to be heated is isolated from the heat source, for example, combustive fuel, and from all other combustion products such as combustion gasses and ash. In the described apparatus herein, a wallboard sample is placed in a muffle furnace for testing such that one side of the wallboard is exposed to heat. The muffle furnace includes an insulation door that forms a cavity between the wallboard sample and an insulating surface. A thermocouple is placed on the side of wallboard that is opposite the heat exposure side, and a computer readable medium or, stated differently, a digital data acquisition device records wallboard surface temperature over time.

In a method for testing wallboard, data acquired from the wallboard sample undergoing testing in the muffle furnace is used to generate temperature-time curves, which are analyzed to calculate an index that is indicative of a predicted fire endurance and/or resistance of the wallboard sample in a full scale fire test. These systems and methods will now be described in more detail in the context of wallboard testing, but it should be appreciated that the described systems and methods are applicable for the prediction of fire endurance of other materials in addition to the wallboards described herein.

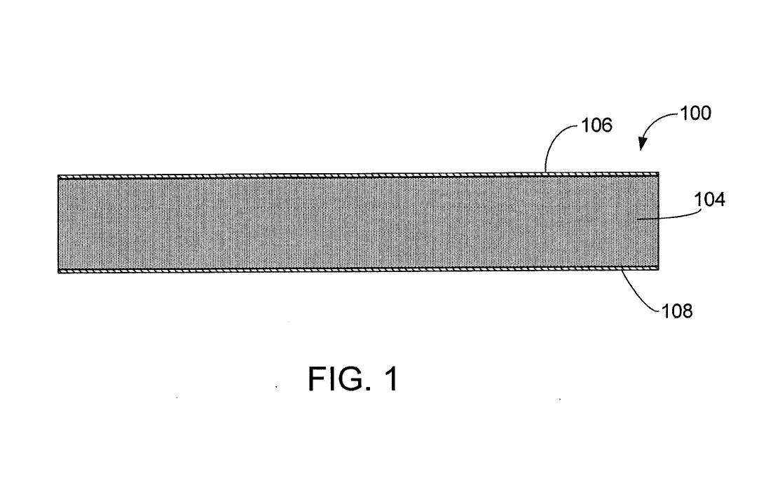

A cross section of a board segment 100 is shown in FIG. 1. The board segment 100 may be a segment of a board made by deposition of a cementitious layer 104, typically applied in slurry form, between first and second paper layers 106 and 108. In the illustration of FIG. 1, the first paper layer 106 may be a so-called back paper layer, and the second paper layer 108 may be a so-called face paper layer, but these layers can be reversed. When the board segment 100 is in use, the face paper layer 108 may be disposed to face inward towards a room interior space, and the back face 106 may face outward relative to the room. Thus, where the face paper layer 108 may include finishing compound, paint and other treatments thereon, the back layer 106 may typically remain bare. As can be seen, the board segment 100 is a composite structure, but it should be appreciated that for other board types, for example, ceiling tiles, which are not typically composite structures, only a back paper layer or no paper layers may be used.

Apart from full-scale, standardized testing for board heat and fire resistance or endurance, as previously described, a small scale test can be used to infer board performance. Existing small-scale tests, which are useful in determining calcination time, i.e., the time required to drive off free and crystallized water from the gypsum panel, are unsuitable for use in predicting board fire performance in a large scale test. This is because large-scale testing includes heat transfer characteristics that affect the board and that result from thermal conduction through the calcined gypsum panel and combustion of organics in the core. One such known small-scale test that is unsuitable for predicting large-scale test fire performance of the wallboard is the so-called “thermal insulation” (TI) test. The TI test was originally developed to determine the rate of heat transfer through a gypsum panel, and is performed by embedding a thermocouple between two disks of board sample with 100 mm (3.937 inches) diameter. The assembled sample is exposed to a 500° C. (932 degree Fahrenheit) temperature in a furnance, and the thermocouple readings are monitored over time. From this information, a TI index is determined by calculating the time for the specimen core temperature to rise from 40 to 200° C. (104 to 392 degree Fahrenheit).

Although the thermal insulation test may be useful in gauging the purity of stucco and the extent of hydration, it is unsuitable for predicting the fire endurance of wallboard under all circumstances. In one experiment, for example, an intumescent coating was applied to board samples at rates of 10.89-36.74 kilograms (24-81 lbs)/MSF. The thermal insulation test indicated a dramatic improvement of the TI index with increasing application rate, but when board samples coated with 18.14 kilograms (40 lbs)/MSF were tested according to E119 for fire endurance in a full-size fire test, the results were significantly lower than those of control. For illustration, where it took 47-48 min for the sample with intumescent coating to reach the threshold temperature in the full-scale test, it took 53-54 min for the control sample.

The drawback of the TI test lies in the temperature applied to test specimen. Thermal insulation index is determined by calculating the time required to heat the sample from 40° C. (104° F.) to 200° C. (392° F.). Such test measures the calcination time, which is the time required to drive off free and crystallized water from the gypsum panel. In a full-scale test, and in the control tests, the time for complete calcination of exposed wall is completed within first 25 min of the test, which means that a majority of heat transfer through the exposed wall is carried out after calcination.

Another drawback of the thermal insulation test is that it cannot be carried out at higher temperatures because the results of the test could be skewed by burning of the paper layers of the board. In one experiment, for example, a temperature curve during a thermal insulation test peaked at about 871.1° C. (about 1600° F.), even though the furnace was set at 500° C. (932° F.). With no malfunction in the furnace operation or control system, it was determined that the increased temperature reading was caused by the combustion of the wallboard paper layer(s) in contact with the thermocouple used for the test.

A notable aspect of the present disclosure is the realization that, fundamentally, the thermal insulation test does not simulate the heat transfer process in a full-size fire test, which leads to the conclusion that the thermal insulation test is unsuitable for correctly predicting fire endurance of wallboard in many situations. Therefore, an alternative testing system and method was devised to better predict the performance of wallboard under fire conditions and for product quality control.

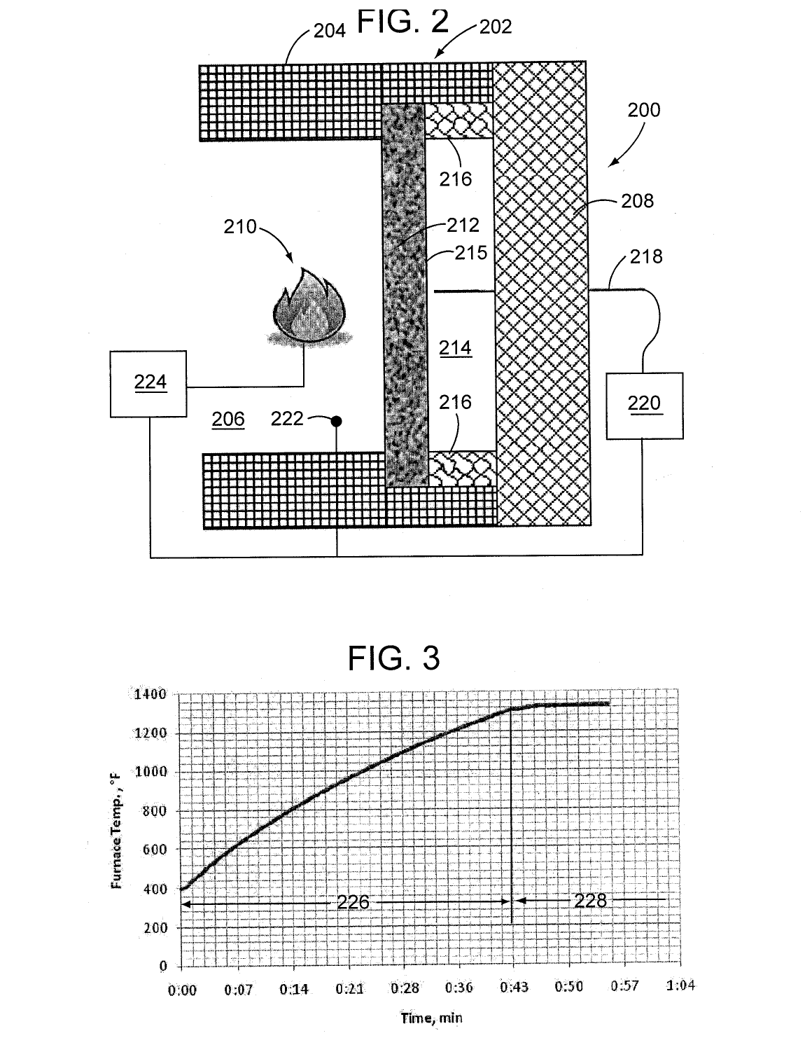

A schematic diagram of a testing system 200 in accordance with the disclosure is shown, in cross section, in FIG. 2. The testing system 200 includes a muffle furnace 202 having an enclosure 204 forming a furnace chamber 206. The chamber 206 is closeable with a door 208 and includes a heat source 210 therewithin. The heat source 210 may be any known type of heat source such as a fuel-fired combustor or an electric-resistive heater, which operates to create a generally uniformly distributed temperature profile within the chamber 206.

In the illustration of FIG. 2, a board sample 212 is shown disposed within the furnace chamber 206 during a test. The sample 212 is mounted vertically within the chamber 206 in the illustrated embodiment at an offset distance from a door opening such that a gap 214 is formed between a back face 215 of the sample 212 and an oven-facing side of the door 208. Spacers 216 are disposed at a distance from one another between the sample 212 and the door 208 to similate studs that space apart wallboards in a finished wall assembly. Although the gap 214 is shown empty, in an alternative embodiment the gap 214 may be filled with a wall-insulation material. Moreover, metal or wooden studs may be used in place of the spacers 216. The spacers may be connected to the sample 212 and, in certain embodiments, may be subjected to a compressive load along with the sample 212 to simulate a load-bearing wall.

A thermocouple 218 or other temperature-sensing device is connected close to the back face 215 of the sample during testing. The thermocouple 218 has a sensing tip at a small distance from the surface of the sample 212. In alternative embodiments, the sending tip can touch or be within the sample 212. The thermocouple 218 is configured to sense a surface temperature or a temperature near the surface of the back face of the sample 212 during testing. The thermocouple 218 is connected to a data acquisition unit 220, which operates to provide power to the thermocouple 218, receive information therefrom indicative of the surface temperature of the sample 212, record the temperature information and, optionally or with the aid of a computer (not shown), plot the temperature information over time or otherwise analyze the information numerically.

When a test is conducted, the temperature of the muffle furnace chamber 206 is gradually increased over time by appropriately controlling the intensity of the heat source 210. In one embodiment, a furnace temperature sensor 222 is disposed to measure the temperature of the furnace chamber 206, provide information indicative of the furnace chamber temperature to a heater controller 224 and, optionally, also to the data acquisition unit 220. The heater controller 224 may operate in a closed loop fashion based on the information provided by the sensor 222 to provide a predetermined heating profile for the chamber 206 by appropriately and automatically adjusting the intensity of the heat source 210. The temperature rise of the chamber 206 may also optionally be recorded by the data acquisition unit 220 for establishing testing integrity.

A sample heating profile of the furnace chamber is shown in the time plot of FIG. 3. As can be seen from the plot, where a desired chamber temperature (° F.) is plotted along the vertical axis and time (min.) is plotted along the horizontal axis, the chamber 206 is heated gradually following a logarithmic trend for about the first 43 minutes of the test from a temperature of about 204.4° C. (about 400° F.) to a temperature of about 772.8° C. (about 1,423° F.), and is maintained at that temperature for the remainder of the test, which in the illustrated graph continues for about 1 hour. Thus, the test is conducted over a first, heating period 226, and then continues over a stable period 228, as marked on the chart of FIG. 3.

It has been determined that heat transfer through the sample 212 during a test, as determined by the measured surface temperature on the back face 215 of the sampe, is concomitant to and indicative of the expected heat transfer through a wallboard in a full scale fire test. In essence, the test describes herein determines the rate of heat transfer through the sample. In one embodiment, temperature readings taken on both sides of the board can be used to estimate, in real time, the heat transfer rate through the board. By comparing the heat transfer curves of different products and correlating the curves to their actual fire test results, judgment and prediction of the performance of fire endurance of different products are advantageously enabled. In the test setup shown in FIG. 2, sample dimension was selected to be a rectangular sample having dimensions of 6.125″×6.625″ and a thickness of 0.625″. The depth of the cavity 214 was 7/8″, and the thermocouple 218 was located in the geometrical center of the door 208, where the sensing probe of the thermocouple 218 protruded about 11/16″ from the inside surface of the door 208 in the direction of the sample 212. In this way, the tip of the thermocouple was 3/16″ away from the surface of the sample. A glass wool frame was placed against the sample to act as the spacer 216 and keep the sample in place while also sealing the door frame against heat leakage. For half-inch thick samples, a metal frame of 0.125″ thickness can be placed behind the sample to maintain the gap between the thermocouple and the sample and preserve the remaining test setup. The controller 224 of the muffle furnace was set to run from 200° C. (392 degree Fahrenheit) to 773° C. (1423 degree Fahrenheit). The actual temperature curve of the muffle furnace at the front end is shown in FIG. 3.

Three exemplary test results will now be discussed to illustrate the effectiveness of the testing system 200 in predicting the fire performance of wallboard samples in full-scale tests.

### EXAMPLE 1

In this first example, the repeatability of the test results was sought to be determined. As is known, good repeatability is a prerequisite for a new test method to be accepted for scientific study or quality control. For this project, excellent repeatability is required to detect small temperature changes caused by formulation and structure. In the process of improving the repeatability of the new small scale fire test, it was discovered that the position of thermocouple, for example, thermocouple 218 (FIG. 2) is important for reducing temperature profile variability in the test results. In reference to the testing arrangement shown in FIG. 2, it was determined that a significant temperature gradient from the door 208 to the surface 215 of the sample 212 was present within the cavity 214, in the range of 10-26.67° C. (50-80° F.). If the position of the thermocouple 218 is not fixed, variability in the measurements will result due to this temperature gradient.

To best measure the properties of the sample and reduce the impact of heat transfer through the cavity 214, the sensing tip of the thermocouple 218 was placed close to the surface 215 of the sample but without entering into it. Measurements on trial samples indicated that the small scale fire test has excellent repeatability.

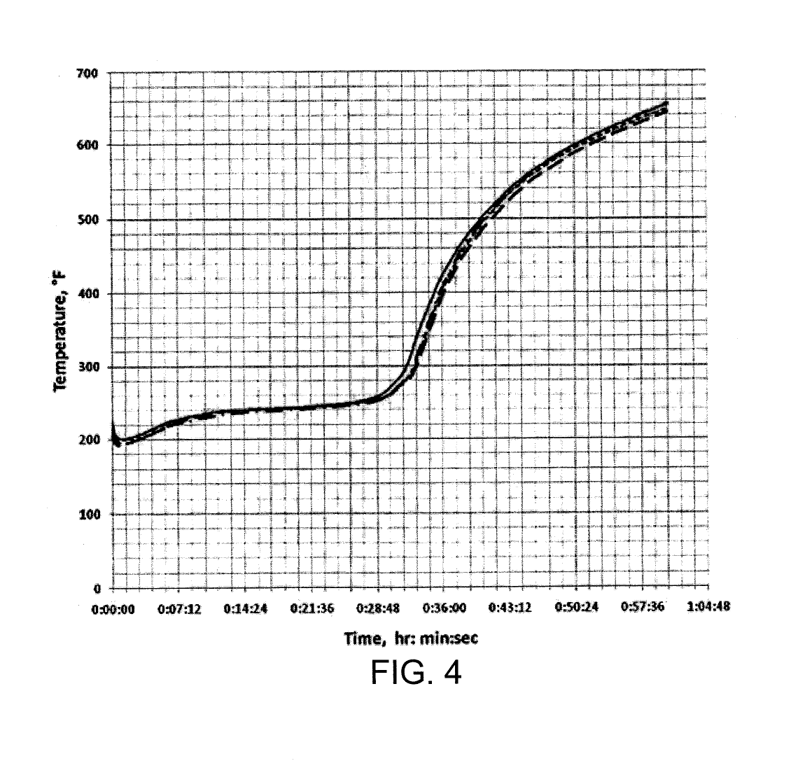

One set of data acquired from the test setup shown in FIG. 2 for four different samples is shown in graphical form in the graph of FIG. 4. In the graph, time is plotted along the horizontal axis in hour:minute:second format, and temperature, expressed in degrees F., is plotted along the vertical axis. For each sample, the temperature was acquired by the thermocouple 218 (FIG. 2), and the oven 202 was run at the same conditions. As can be seen in the graph, each of four temperature traces substantially overlap or are within ±2% of one another with respect to the higher temperature readings acquired. The four samples tested consisted of wallboard pieces taken from different production batches. The properties and dimensions of each sample were measured and are provided in Table 1 below, along with an identification of the corresponding temperature trace for that sample as shown in FIG. 4.

TABLE 1

| | | Basis Weight | Thickness |
|---|---|---|---|
| | FIG. 4 representation | (lbs/1000 ft²) | (inches) |
| Sample 1 | Long-dashed line | 1765 | 0.628 |
| Sample 2 | Dash-dot line | 1771 | 0.629 |
| Sample 3 | Solid line | 1767 | 0.629 |
| Sample 3 | Short-dashed line | 1789 | 0.633 |

Testing of the four samples indicated that the small-scale fire testing system 200 (FIG. 2) has excellent repeatability.

### EXAMPLE 2

For the second example, a time-related parameter that quantitatively characterizes the expected or predicted fire performance of tested samples, which is referred herein as the Fire Endurance Index (FEI), was determined by considering temperature traces. The FEI is used to predict the fire endurance of each corresponding sample tested under a full-scale fire test in accordance with ASTM E119. FEI is defined as the time required to reach 315.6° C. (600° F.) at the backside of a test specimen in the small scale fire test. The temperature of 315.6° C. (600° F.) is arbitrary and may vary for different purposes. For example, the predetermined threshold temperature can be from about 250° C. to about 800° C. (about 482° F. to about 1472° F.). In the present disclosed embodiments, the threshold temperature of 315.6° C. (600° F.) was selected because it is a sufficiently high temperature that ensures that most combustible substances present in the core of the wallboard will have sufficiently burned off such that a maximum amount of heat is transferred through the board. Also at this temperature, any temperature gradients across a wall cavity within a wall assembly of a full-scale fire test assembly will be maximized. At least from these aspects, the time required for the back surface of the test sample 212 (FIG. 2) to reach around 315.6° C. (600° F.) was selected as a representative indication of the sample's fire performance.

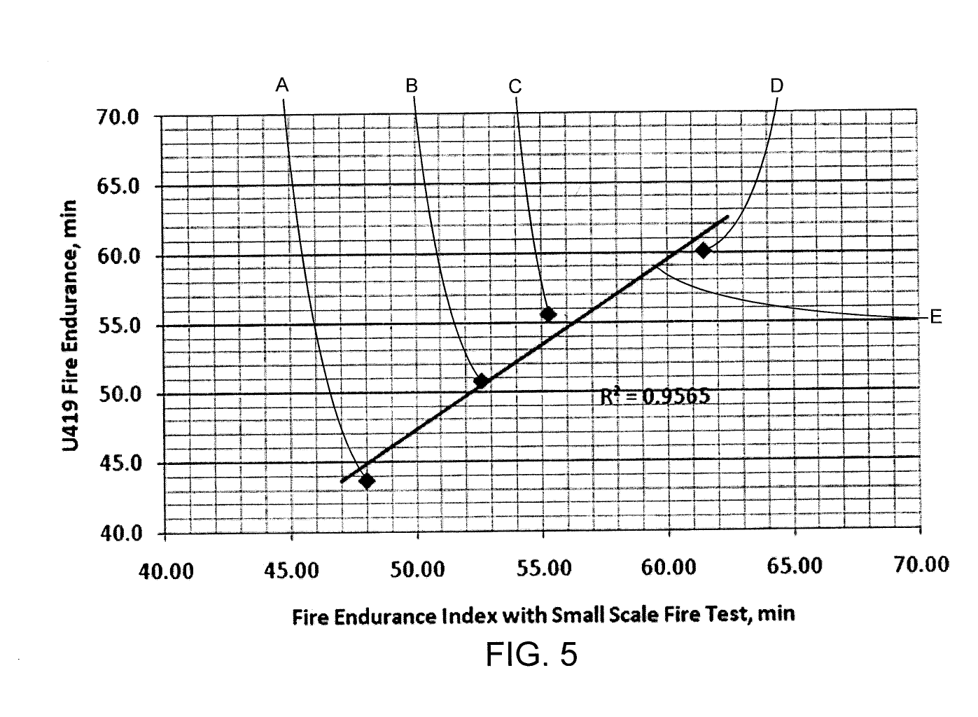

A correlation between the FEI for four different samples, which was determined by use of the small-scale fire test in accordance with the present disclosure, and a full-scale fire test conducted in accordance with UL® U419 standard test, is shown in FIG. 5. In this figure, four points labeled A, B, C and D are plotted against two axis. The FEI, expressed in minutes, is plotted along the horizontal axis, and the UL® U419 fire endurance for each sample is plotted along the vertical axis. Each point, therefore, represents both the FEI and UL® U419 fire endurances of each of the four samples. A straight line, E, is fit between the four points. The line, E, has a fit quality of R²=0,9565, which indicates a good fit and, thus, a good correlation between the FEI determined for each sample and the corresponding UL® U419 fire endurance. In the same fashion, correlations can be determined for other types of standard testing, such as as for the UL® U305 and UL® U423 tests.

### EXAMPLE 3

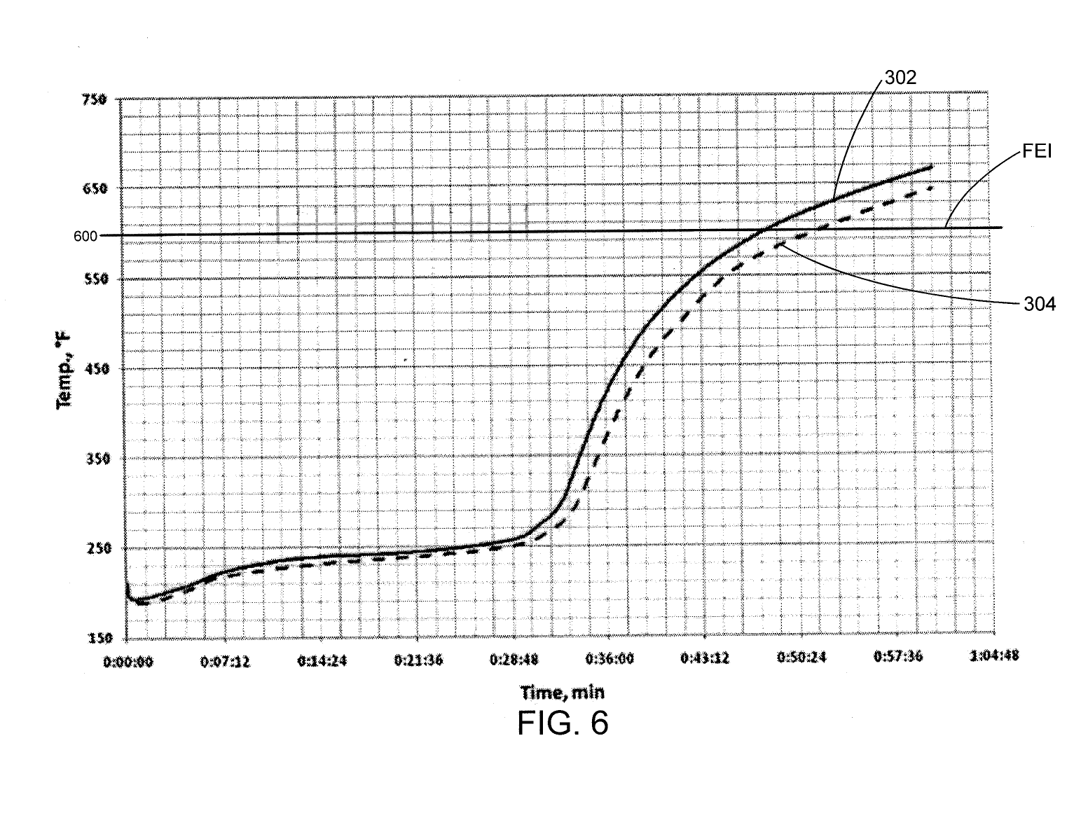

In this third experiment, the effect of fire-resitance treatment on the boards, as well as the predictability of full-scale test results on the basis of the FEI determined using the small-scale test described herein were determined and confirmed. Accordingly, a control sample was produced on a manufacturing line having a thickness of 0.617 in., a basis weight of 762.5 kilograms (1681 lbs)/1000 ft², and a density of 14.84 kilograms (32.72 lbs)./ft³ density. Two sample pieces measuring 6.625 in.×6.125 in. were cut from a 4 ft×10 ft board of the control sample. One of the two sample pieces was subjected to a fire-resistant treatment to reduce its heat transfer rate, and was conditioned for at least 24 hours. The treated and un-treated sample pieces were then tested in the system 200 (FIG. 2) to determine their respective FEI using the small-scale fire test described herein. Temperature traces for each of the two samples are shown in FIG. 6, where time is plotted along the horizontal axis and temperature of the back-face of each sample is plotted along the vertical axis. In the chart of FIG. 6, the solid line 302 represents the temperature trace for the un-treated sample, the dashed line 304 represents the temperature trace for the treated sample, and a “FEI” line extends horizontally from a temperature of 315.6° C. (600° F.) to denote the FEI indexes for both samples.

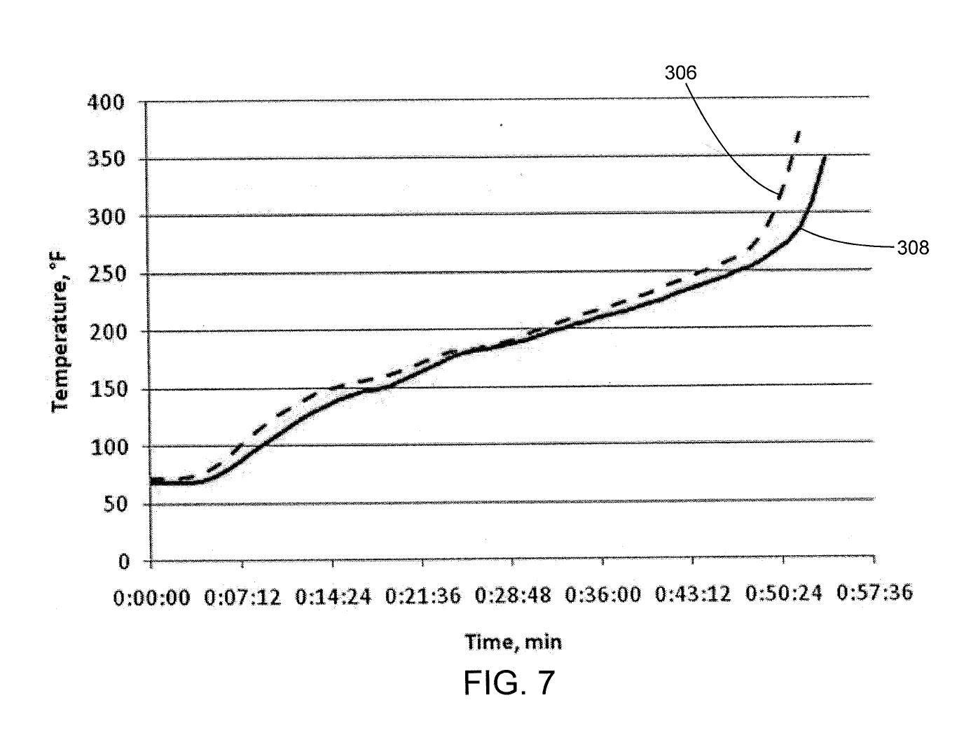

As can be calculated from the graph of FIG. 6, the FEI is 48.0 minutes for the un-treated sample piece, i.e., the control sample, and the FEI is 52.0 minutes for the treated sample piece. On the basis of the small-scale test, a 4-min improvement of fire endurance as a result of the treatment applied was predicted. A full-scale UL® U419 test using trial boards was also conducted to confirm the 4-minute improvement prediction. For the full-scale test, trial wallboards were made at the same manufacturing facility as the control sample was previously made using the same board formulation as was used for the small-scale fire test. The sample boards for the full-scale test were measured and determined to have a board thickness of 0.620 in, a basis weight of 781.5 kilograms (1723 lbs)/1000 ft², and a density of 15.13 kilograms (33.35 lbs)/ft³. Certain sample boards were subjected to the fire-resistance treatment and were conditioned for 24 hours in identical fashion to the sample used in the small-scale test. Both treated and un-treated boards were then subjected to a standard full-size fire test with an appropriate assembly design for the UL® U419 test. The fire endurance results of the full scale UL® U419 fire tests using the treated and un-treated board samples is shown in FIG. 7, where testing time is plotted against the horizontal axis and the temperature of unexposed surfaces of the samples is plotted along the vertical axis.

In FIG. 7, a dashed-line curve 306 represents the temperature trace for the un-treated sample, and a solid-line curve 308 represents the temperature trace for the treated sample. As previously mentioned, the fire endurance for the UL® U419 test is the time for the unexposed surfaces of the boards to reach 121.1° C. (250° F.) above ambient. Based on the conditions of the test, it was determined that the control board (curve 306) had a fire endurance of 49 minutes and 53 seconds, while the treated board (curve 308) had a fire endurance of 53 minutes and 16 seconds. In other words, the treatment appeared to increase board endurance by about 3 minutes and 23 seconds. The fire test results in this example validate the small-scale fire test in terms of both absolute values and also the difference between treated and untreated samples.

In general, the present disclosure is applicable to testing, on a small-scale, the fire endurance and/or resistance of building materials such as wallboard. In full-scale testing, wall assemblies of predetermined dimensions are assembled using two skin layers and a support layer of building materials. These wall assemblies are exposed to an ignition source to determined the fire resistance and/or endurance of the building materials. The time and expense of such standardized testing procedures makes them unsuitable for regular use by building material manufacturers such as wallboard manufacturers for quality control and testing on a regular basis ini a manufacturing environment. Moreover, existing small-scale tests are incapable of yielding results bearing a correlation to standard testing results.

The present disclosure involves a small-scale fire testing system and method that yields repeatable results, which advantageously bear a strong correlation with results producted by standard testing techniques but at a fraction of the cost and time required for those standard tests. In this way, the small-scale tests can be used to quickly and cost-effectively conduct testing for research purposes, for example, when developing new building material fire-resistance technologies, and can also be used to perform periodic testing of manufactured products to ensure consistent quality and performance, which was not possible heretofore.

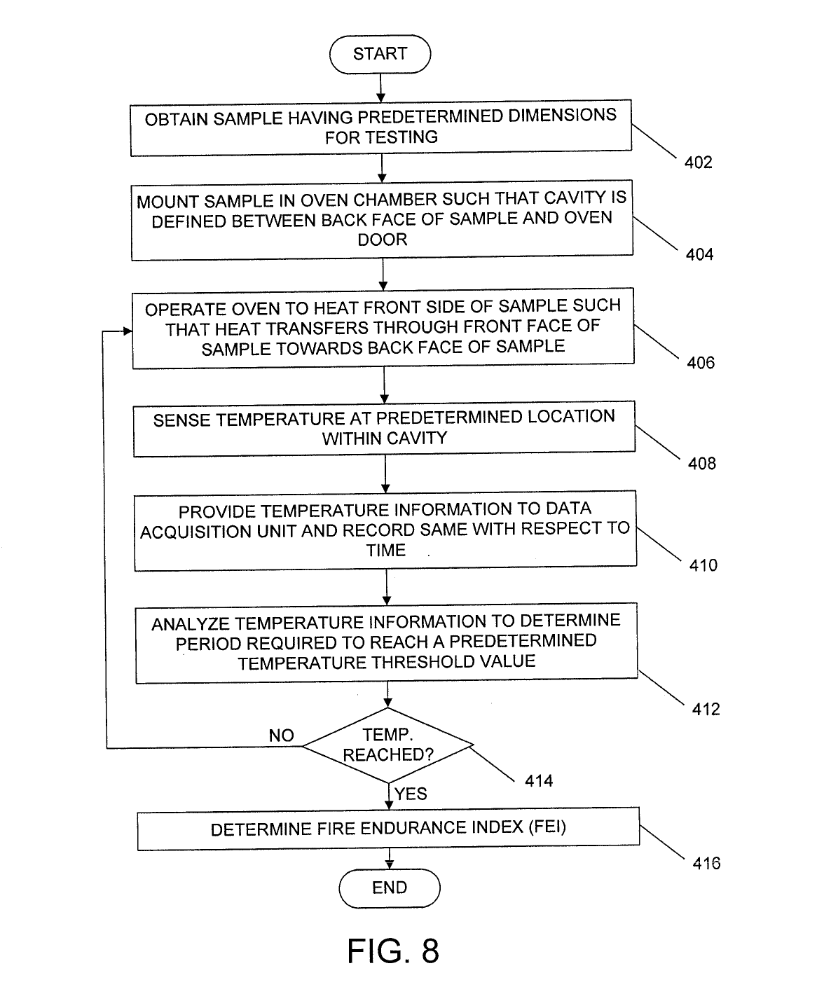

A flowchart for a testing method in accordance with the disclosure is shown in FIG. 8. The described testing method will be discussed in the context of wallboard testing as an exemplary embodiment, but it should be appreciated that the method is applicable to the testing of other products such as cement boards, ceiling tiles, and other building products. In accordance with the method, a sample to be tested having predetermined dimensions is obtained at 402. The sample is mounted into an oven chamber in spaced relation with an oven door enclosing the oven chamber such that cavity is defined between a back face of the sample and the oven door at 404. In one embodiment, a spacer is disposed between the sample and the door to seal the oven chamber around the sample. The oven is operates at 406 to heat a front face of the sample. During heating of the front face of the sample, heat will transfer through the sample to increase a temperature of the back face of the sample. In one embodiment, the oven chamber is heated in accordance with a predetermined heating profile that gradually increases for a first period and then remains generally constant for a second period.

Notwithstanding any temperature gradients in the cavity between the sample and the oven door, a temperature is sensed at a predetermined location within the cavity at 408. The sensed temperature is provided to a data acquisition unit at 410, where it is recorded with respect to time. The temperature information is analyzed to determine the period required for the sensed temperature to reach a predetermined threshold value at 412. In one embodiment, the predetermined temperature is 315.6° C. (600° F.). In the testing process, a decision is made at 414 whether the predetermined threshold temperature has been reached. While the temperatre is below the threshold temperature, the heating process continues and temperature information is continually collected and analyzed. When the predetermined temperature has been reached, or exceeded, the period until the predetermined temperature was reached is recorded, for example, as the so-called fire endurance index (FEI), and the test is terminated as completed.

For wallboard samples of typical composition and thickness, as used in the building industry, typical times for the samples to reach the predetermined temperature can range anyqhere from 45 to 60 minutes, or more,which means that the small-scale testing described herein, including sample and over preparation, can be completed in fewer than four hours. This means that a single technician can conduct about two to three complete tests in a single shift, which makes this test suitable for use in a manufacturing environment as an end-of-line quality control test for wall board production facilities. Specifically, it is contemplated that the small-scale test described herein can be used on a regular basis at a wallboard manufacturing facility to test each batch of wallboard produced to ensure consistent quality with respect to fire endurance and/or resistance.

As is known, wallboard manufacturing processed include various steps. Most commercially available gypsum boards (ceiling panels or wall boards) are composite structures made from a gypsum core and a cover sheet on each side of the board. The core typically includes gypsum and a starch binder. The cover sheets can be either cellulosic paper or fiberglass mat. The paper on the face side of the board, which is the side visible when the board is built into a wall has a smooth texture suitable for painting or other finishes. The paper on the back side of the board, i.e. the side of the board connected to a stud or other building structure, may have a rougher texture. The paper on the face side of the board may be different from paper on the back side of the board in that it has a white liner on its surface.

During formation of gypsum boards, a slurry is prepared by mixing water with stucco (calcined gypsum), starch, accelerator, and/or other additives at a predetermined ratio. A continuous paper web or glass mat is placed on a conveyor as the first cover sheet. The slurry is deposited onto the web and spread across the width of the web at a predetermined thickness to form the core of the board. A second sheet is placed on top of the wet slurry to form a so-called “envelop.” As the board travels along the conveyor, the stucco gradually hydrates and the slurry in the “envelop” hardens. The at least partially hardened slurry, along with the paper facings, is cut into boards having desired sizes, and carried into a kiln for drying.

In the kiln, the wet boards are dried to a desired level of free moisture content. The resultant boards may be further processed into different sizes. The typical thickness of gypsum boards is 1.27 centimeters (½ inch) and 1.587 centimeters (⅝ inch), but may range from 0.635 centimeter (¼ inch) to 2.54 centimeters (1 inch). It is contemplated that, after kiln drying and, optionally, a resting period, board samples may be cut and tested using the small-scale test described herein as part of controlling the quality of the manufactured boards for fire endurance and/or resistance.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method for predicting wallboard fire performance in a standard test, comprising:
mounting a sample of a wallboard to be tested into a fixture so that one side of the sample is exposed to a heat source;
creating a cavity between the sample and the fixture, wherein the sample is disposed between the heat source and the cavity;
measuring a temperature at a predetermined location within the cavity over time;
monitoring the temperature over time, and recording a series of temperature readings using a computer-readable medium;
analyzing the series of temperature readings, at least in part, by creating a temperature trace of the series of temperature readings over time, and by determining an index time at which the temperature reaches a predetermined temperature threshold at the predetermined location within the cavity;
correlating the index time to the fire performance of the standard test using the computer-readable medium; and
based on the correlation, predicting the fire performance of the wallboard in the standard test.

2. The method of claim 1, wherein the standard test involves exposing a sample wall assembly constructed by connecting two layers of wallboard with studs, exposing one side of the wall assembly to a heat source, and monitoring an opposite side of the wall assembly.

3. The method of claim 1, wherein the sample has predetermined dimensions.

4. The method of claim 1, wherein the fixture includes a muffle oven having an internal chamber subject to heating and a door enclosing the internal chamber, wherein the sample is mounted such that it extends across an opening of the internal chamber and at an offset distance from a door opening, and wherein the cavity is defined between the sample and the door, when the door is in a closed position, along the offset distance.

5. The method of claim 1, wherein exposing the sample to a heat source includes increasing an intensity of the heat source and, therefore a temperature of the heat source, according to a predetermined schedule.

6. The method of claim 5, wherein the predetermined schedule includes a first phase, in which the temperature of the heat source is gradually increased for a predetermined period.

7. The method of claim 1, wherein the predetermined location within the cavity is adjacent to, but not in contact with, a surface of the sample.

8. The method of claim 1, wherein the wallboard is a composite structure including a core made of gypsum and faces made of paper, and wherein the predetermined temperature thereshold is sufficiently high to ensure that organic material in the wallboard have burned off.

9. The method of claim 1, wherein the predetermined threshold temperature is from about 250° C. to about 800° C. (about 482° F. to about 1472° F.).

10. The method of claim 1, wherein the sample possesses physical and chemical characteristics that may change between different wallboard production batches, wherein the sample is representative of such characteristics for a particular batch, wherein a particular fire performance in a standard test is a desired wallboard design parameter, and wherein the method for testing is part of an end-of-line quality test for the particular wallboard production batch.

11. A method for testing the fire endurance and/or performance of a wallboard sample, comprising:
mounting the wallboard sample across an opening of a chamber of a muffle furnace having temperature control, wherein one side of the wallboard sample is exposed to an oven temperature;
creating a cavity between the wallboard sample and an oven door configured to enclose the chamber;
measuring a sample temperature at a predetermined location within the cavity over time;
monitoring and recording the sample temperature with respect to time using a computer-readable storage medium;
analyzing sample temperature information at least in part, by creating a temperature trace and by determining an index time at which the sample temperature reaches a predetermined temperature threshold;
correlating the index time to a fire performance of a standard test using the computer-readable medium; and
based on the correlation, predicting the fire performance of the wallboard in the standard test.

12. The method of claim 11, wherein the standard test involves exposing a sample wall assembly constructed by connecting two layers of wallboard with studs, exposing one side of the wall assembly to a flame source, and monitoring an opposite side of the wall assembly.

13. The method of claim 11, wherein the predetermined location within the cavity corresponds to a geometric center of the sample.

14. The method of claim 11, wherein the oven temperature is increased according to a predetermined schedule.

15. The method of claim 14, wherein the predetermined schedule includes a first phase, in which the oven temperature is gradually increased for a predetermined period.

16. The method of claim 11, wherein the predetermined location within the cavity is adjacent to a surface of the sample that at least partially defines the cavity.

17. The method of claim 11, wherein the wallboard sample is a composite structure including a core made of gypsum and faces made of paper, and wherein the predetermined temperature thereshold is sufficiently high to ensure that organic material in the wallboard have burned off.

18. The method of claim 11, wherein the predetermined threshold temperature is from about 250° C. to about 800° C. (about 482° F. to about 1472° F.).

19. The method of claim 1, wherein the sample possesses physical and chemical characteristics that may change between different wallboard production batches, wherein the sample is representative of such characteristics for a particular batch, wherein a particular fire performance in a standard test is a desired wallboard design parameter, and wherein the method for testing is part of an end-of-line quality test for the particular wallboard production batch.

20. A method for producing wallboard, comprising:
building a composite wallboard structure in a manufacturing facility using a particular batch of gypsum slurry to form a core portion of the composite wallboard structure;
extracting a sample of the composite wallboard structure;
testing the sample in a small-scale test so that a fire performance of the composite wallboard structure in a full-scale test can be extrapolated, said testing being carried out by:
mounting the sample into a fixture so that one side of the sample is exposed to a heat source;
creating a cavity between the sample and the fixture, wherein the sample is disposed between the heat source and the cavity;
measuring a temperature at a predetermined location within the cavity over time;
monitoring the temperature over time, and recording a series of temperature readings using a computer-readable medium;
analyzing the series of temperature readings, at least in part, by creating a temperature trace of the series of temperature readings over time, and by determining an index time at which the temperature reaches a predetermined temperature threshold at the predetermined location within the cavity;
correlating the index time to the full-scale test using the computer-readable medium;
based on the correlation, predicting a fire performance of the composite wallboard structure in the full-scale test; and
releasing the composite wallboard structure for sale to consumers when the fire performance of the composite wallboard structure is predicted to be within acceptable parameters.
